(19) United States
(12) Patent Application Publication
(10) Pub. No.: US 2006/0227063 A1
(43) Pub. Date: Oct. 12, 2006

(54) Star-rib backing structure for a reflector system

(75) Inventors: John E. Richer, Carlsbad, CA (US); Raymund S. Cabales, San Diego, CA (US); Carl M. Sloan, San Diego, CA (US); Jerry W. Mann, Temecula, CA (US)

Correspondence Address: STETINA BRUNDA GARRED & BRUCKER, 75 ENTERPRISE, SUITE 250, ALISO VIEJO, CA, 92656, US

(73) Assignee: Vanguard Composites Group, Inc.

(21) Appl. No.: 11/100,671

(22) Filed: Apr. 7, 2005

(51) Int. Cl. H01Q 15/14

(52) U.S. Cl. 343/912; 343/DIG. 2

(57) ABSTRACT

A backing structure of an antenna reflector for satellite communication to increase the stiffness and the frequency of the antenna reflector, having a deployable panel attached to a spacecraft at a hinge/gimbal interface and a plurality of hinge-release points. The backing structure has a plurality of first ribs and second ribs protruding from the deployable panel and extending substantially across the center of mass of the deployable panel. The first ribs connect the hinge-release mechanism points across a center of mass of the deployable panel, and the second ribs connect the hinge/gimbal interface point to the hinge-release mechanism points, which allows improved hinge-release mechanism attachment with a nut.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates in general to a reflector antenna, and more particularly, to a dual-shell satellite reflector assembly with an improved rear structure designed to increase stiffness, reduce distortion during the lifetime of the reflector, and improve structural attachment of holddown fittings.

Satellite antenna systems are used to receive and transmit signals to and from the satellite. The transmit antenna is typically mounted on one side of a spacecraft to transmit signals from the spacecraft to receivers on the earth. During launch, the transmit antenna is secured to the spacecraft in the stowed configuration via four individual attach points and a hinge/gimbal interface. After the spacecraft has reached its intended orbit, the attach points are released and the antenna is deployed from the hinge mechanism at the hinge/gimbal interface.

A dual-shell reflector is typically used when a linearly polarized output is required. Particularly, such type of reflector is necessary to provide coverage on orthogonal polarizations.

The principal components of a typical dual-shell reflector include a front shell and a rear shell separated from each other by a circumferential or “intercostal” ring, and a backing structure. All the components are bonded together with a structural adhesive to obtain a unitized structure. The front shell is typically comprised of Kevlar™ skins co-cured to Kevlar™ or Korex™ core, which provides an RF-transparent surface. Grids are formed on the surface of the front shell to control polarization. The grids are spaced from each other with a predetermined distance to provide optimal electrical performance. An electrical energy within a first frequency range is fed to the surface of the front shell and reflected off the grids. An electrical energy within a second frequency range is also fed to the surface of the front shell. The electrical energy within the second frequency range transmits through the front shell and is reflected off the surface of the rear shell. The rear shell is constructed from carbon fiber skins co-cured to Kevlar™ or Korex™ core. The fiber carbon sandwich of the rear shell ensures electrical isotropic performance and maintains polarization purity. Similar to the front shell, the intercostal ring is a sandwich construction comprised of Kevlar™ skins co-cured to Kevlar™ or Korex™ core to allow specific frequencies to be received by and reflected from the rear shell. The backing structure is fabricated from carbon fiber skins co-cured to Kevlar™ or Korex™ core bonded together using a structural adhesive. The high specific stiffness of the carbon fiber backing structure acts to reduce distortion during launch and minimize the thermoelastic distortions of the structure during the lifetime of the satellite.

The typical satellite structure requires four hinge release mechanism (HRM) to hold the antenna in the stowed configuration until it reaches its intended orbit. One conventional design of the backing structure uses carbon fiber cylindrical tubes to encapsulate metallic fittings for tie-down of the antenna. The metallic fittings are bonded to the tubes. The sandwich panels or ribs of the conventional backing structures are bonded to the tubes to create a box-type of frame.

The conventional designs of the backing structure have several drawbacks. A common frequency requirement for antenna structures at launch condition is 55 Hz, while an analytical prediction shows that the launch frequency of the conventional design ranges approximately 45 Hz to 60 Hz. The material difference between the tie-down tube and the metallic fitting results in risk of disengagement at thermal excursions. Further, these designs do not efficiently distribute the loads between each of the hinge release mechanisms and the hinge/gimbal locations.

It is therefore a substantial need to provide a reflector backing structure that overcomes the drawbacks.

### BRIEF SUMMARY OF THE INVENTION

A backing structure of an antenna reflector for satellite communication is provided to increase the stiffness and the frequency of the antenna reflector. The antenna reflector includes a deployable panel attached to a spacecraft at hinge/gimbal interfaces and a plurality of hinge-release points, and the backing structure comprises a plurality of first ribs and second ribs protruding from the deployable panel and extending substantially across the center of mass of the deployable panel. The first ribs connect the hinge-release mechanism points across a center of mass of the deployable panel, and the second ribs connect the hinge/gimbal interface points to the hinge-release mechanism points.

Preferably, the first and second ribs are fabricated from sandwich panels of graphite skin and honeycomb core. In one embodiment, the backing structure preferably includes two hinge-release mechanism points distal to the hinge/gimbal interface point and two hinge-release mechanism points proximal to the hinge/gimbal interface point. Therefore, there are two first ribs extending between the proximal hinge-release mechanism points and the distal hinge-release mechanism points at different sides of the center of mass, and two second ribs extending between the hinge-gimbal interface point and the distal hinge-release mechanism points. Preferably, a third rib is formed to extend laterally to connect two of the hinge-release mechanism points to form a star-like rib structure on the reflector panel.

Preferably, each hinge-release mechanism point comprises a metal fitting and a nut for retaining the metal fitting, and each metal fitting includes a plurality of threads engagable with the nut. The nut prevents disengagement of the fitting at thermal excursions. The antenna reflector comprises a dual-shell deployable panel interconnected by a circumferential ring or a single-shell deployable panel.

An antenna reflector deployably attached to a spacecraft is also provided to overcome the drawbacks of the conventional design. The antenna reflector comprises a reflector panel, a hinge-gimbal interface, a plurality of hinge-release mechanisms and a star-like rib backing structure. The hinge-gimbal interface deployably connects the reflector panel to the spacecraft. The reflector panel is also releasably connected to the spacecraft by the hinge-release mechanisms. The star-like ribs extend between the hinge-gimbal interface and the hinge-release mechanisms to provide a plurality of direct load transfer paths to a center of mass of the reflector panel.

In one embodiment, each of the hinge-release mechanisms comprises one threaded metallic fitting and one nut to retain the threaded metallic fitting. The star-like rib is preferably fabricated from sandwich panels of graphite skin and honeycomb core. The star-like rib includes two longitudinal ribs extending across the center of mass and connecting the hinge-gimbal interface to two hinge-release mechanisms, and two diagonal ribs each extending across the center of mass and connecting two hinge-release mechanisms at two diagonal positions of the reflector panel. One lateral rib may also be formed to connect two hinge-release mechanisms proximal to the hinge/gimbal interface. The antenna reflector can be either a single-panel structure or a dual-panel structure that includes a front panel and a rear panel.

A method of increasing stiffness of an antenna reflector is also provided. The antenna reflector includes a reflector panel deployably connected to a hinge/gimbal interface and releasably connected to a plurality of hinge-release mechanisms of a spacecraft. A plurality of protruding ribs is formed on the reflector panel to extending across a center of mass of the reflector panel between the hinge-mechanisms. At least two protruding ribs are also formed to extend across the center of mass between the hinge/gimbal interface and the hinge-release mechanisms. A lateral protruding rib may also be formed to connect two hinge-release mechanisms proximal to the hinge/gimbal interface.

### BRIEF DESCRIPTION OF THE DRAWINGS

These as well as other features of the present invention will become more apparent upon reference to the drawings wherein:

FIG. 1 shows a perspective view of an antenna reflector attached to a spacecraft in a stowed configuration;

FIG. 2 shows a top view of an exemplary backing structure;

FIG. 3 shows a perspective view of another exemplary reflector panel;

FIG. 4 shows an exemplary hinge-release mechanism;

FIG. 5A shows the engaged mode of another exemplary hinge-release mechanism; and

FIG. 5B shows the released mode of the hinge-release mechanism as shown in FIG. 5A.

### DETAILED DESCRIPTION OF THE INVENTION

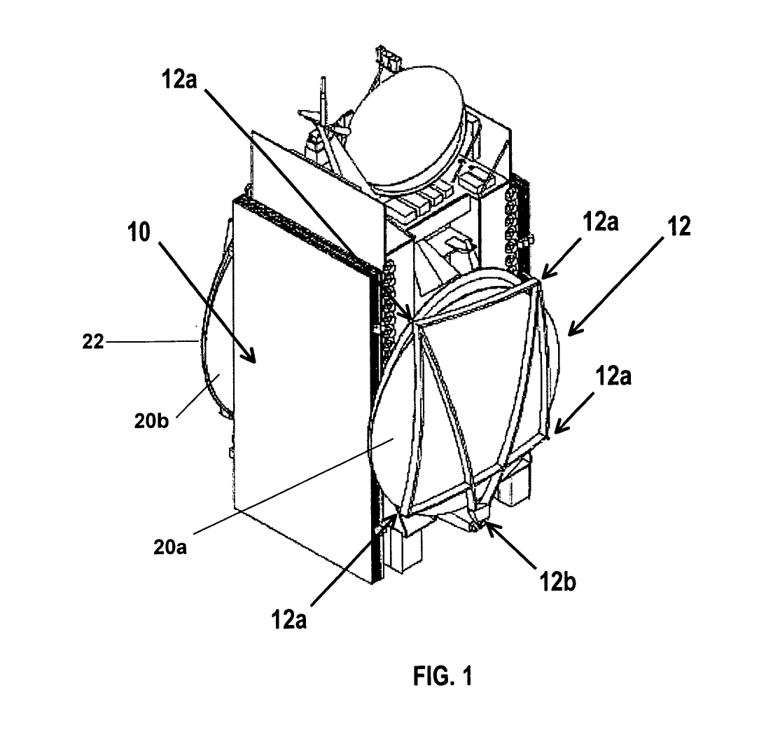

Referring now to the drawings wherein the showings are for purpose of illustrating preferred embodiments of the present invention only, and not for purposes of limiting the same, FIG. 1 shows a structure having a pair of reflectors 12 deployably attached to two opposing sides of a spacecraft 10. Each of the reflectors 12 includes a front shell 20a, a rear shell 20b, and a ring 22 interconnecting the front and rear shells 20a and 20b at the peripheries thereof. Each of the reflectors 12 is attached to the respective side of the spacecraft 10 at a plurality of tie-down points through a backing structure. In this embodiment, the tie-down point for each reflector 12 is a hinge/gimbal interface point 12b at the bottom of the reflector 12 and four hinge-release mechanism points 12a. When the spacecraft has reached its intended orbit, the reflectors 12 are released at the hinge-release mechanism points 12a and deployed about the hinge/gimbal interface point 12b to perform signal transmission.

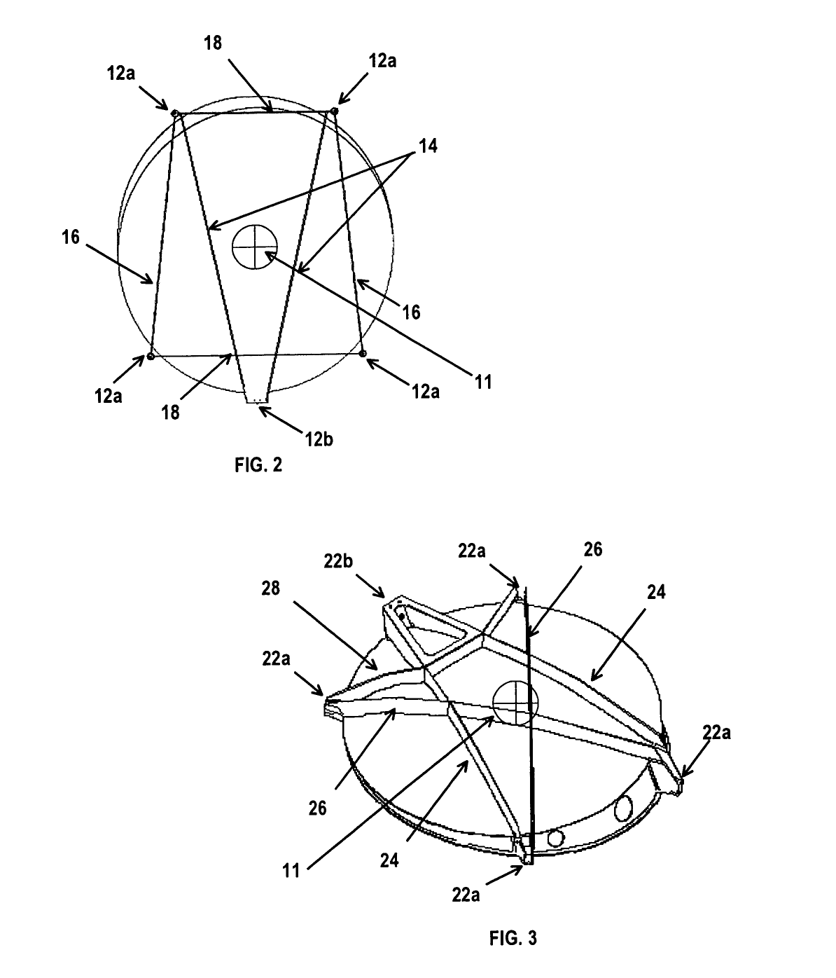

As shown in FIG. 1, two of the hinge-release mechanism points 12a distal to the hinge/gimbal interface point 12b are located at the upper periphery of the reflector 12, while two of the hinge-release mechanism points 12a proximal to the hinge/gimbal point 12b are located at the lower periphery of the reflector 12 at two sides of the hinge/gimbal interface point 12b. When the spacecraft 10 launches, vibration is generated and loaded from a center of mass (COM) of the reflector 12 to the tie-down points 12a and 12b. To avoid the load being transferred to the tie-down points 12a and 12b through the surfaces of the front shell 20a and rear shell 20b, load paths are provided on the surface of the rear shell 20b. For example, as shown in FIG. 2, two protruding ribs 16 are formed to interconnect the adjacent hinge-release mechanism points 12a along the longitudinal direction, two protruding ribs 18 are formed to laterally interconnect adjacent hinge-release mechanism points 12a, and two protruding ribs 14 are formed to connect the hinge/gimbal interface point 12b to the distal hinge-release mechanism points 12a at the upper periphery of the reflector 12. Thereby, under both bending and torsion modes, four substantially longitudinal ribs 14 and 16 and two substantially horizontal ribs 18 are formed to provide load paths between the center of mass 11 and the tie-down points 12a and 12b, so as to increase the stiffness of the reflector 12.

However, as the protruding ribs 16 and 18 are formed to interconnect the hinge-release mechanism points 12a at the same sides of the center of mass, only the protruding ribs 14 that connect the hinge/gimbal interface point 12b and the distal hinge-release mechanism points 12a extend closely to the center of mass 11. That is, only the protruding ribs 14 provide direct load paths from the center of mass. The indirect load path established by the protruding ribs 16 and 18 still transfer the load from the center of mass to the hinge mechanism points 12a through the rear shell 20b, which is mostly unsupported at the center of mass. Thereby, a lower frequency of the reflector structure is resulted.

To prevent from transferring load from the rear shell 20b, so as to avoid lowering the frequency of the reflector structure, a star-like rib structure is formed to provide more load paths extending near or across the center of mass. As shown in FIG. 3, instead of the protruding ribs connecting the hinge-release mechanism points 22b a at the same side of the center of mass 11, the star-like rib structure includes two diagonal protruding ribs 26 formed on the front shell 20a to interconnect the distal and proximal hinge-release mechanism points 22a at different sides of the center of mass. In addition to the diagonal protruding ribs 26, protruding ribs 24 are formed to interconnect the hinge/gimbal interface point 22b and the distal hinge-release mechanism points 22a. Thereby, four protruding ribs 24 and 26 are formed to extend close to or across the center of mass 11 of each reflector 12 to provide direct load transfer paths for the center of mass 11. The direct load paths of load transfer effectively transfers load from the center of mass to the hinge-release mechanism points 22a and the hinge/gimbal point 22b without applying the load to the front and rear shells 20a and 20b, such that the overall stiffness of the reflector structure is enhanced. In addition to the protruding ribs 24 and 26, the star-like rib structure further comprises a lateral protruding rib 28 connecting the proximal hinge-release mechanism points 22a. As shown, the lateral protruding rib 28 intersects with the protruding ribs 24 and is bent with an angle at the intersections.

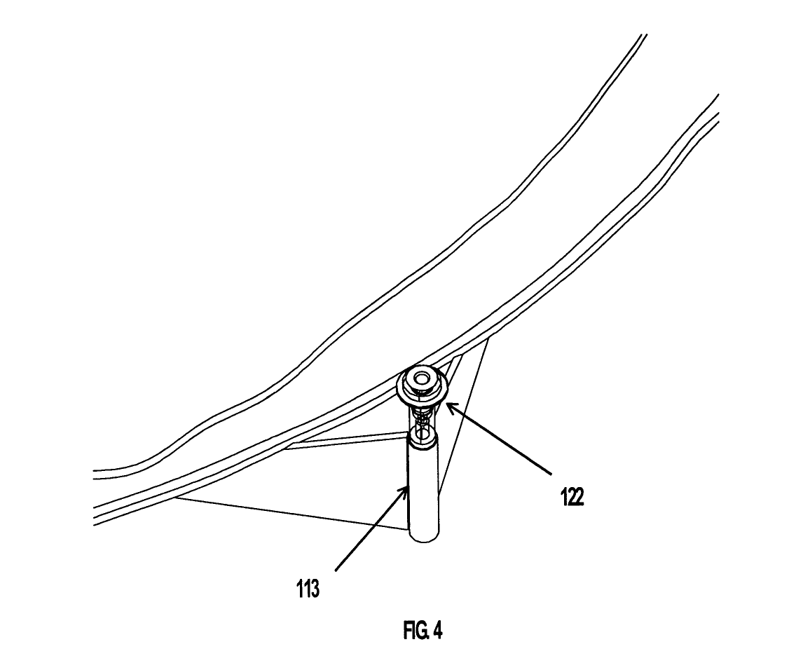

FIG. 4 shows a joint design of the hinge-release mechanism points 22a. As shown, the joint design of each hinge-release mechanism point 22a includes a metallic hinge-release mechanism fitting 122 bonded to a graphite composite tube 113. The joint relies fully on the integrity of the bond to hold the fitting in place. Such bondline is prone to failure during thermal excursion due to the effective stress resulting from thermally induced stress of dissimilar materials, metal and graphite composite. The stress is significantly high and the bond of a metal fitting to a graphite tube can fail simply by exposing the assembly to the cold temperature reflector structures typically seen. To resolve such problem, the metal fitting is fabricated from a metal with a lower coefficient of thermal expansion (CTE) such as invar. However, the metal fitting made of invar is nearly two times heavier that made of titanium.

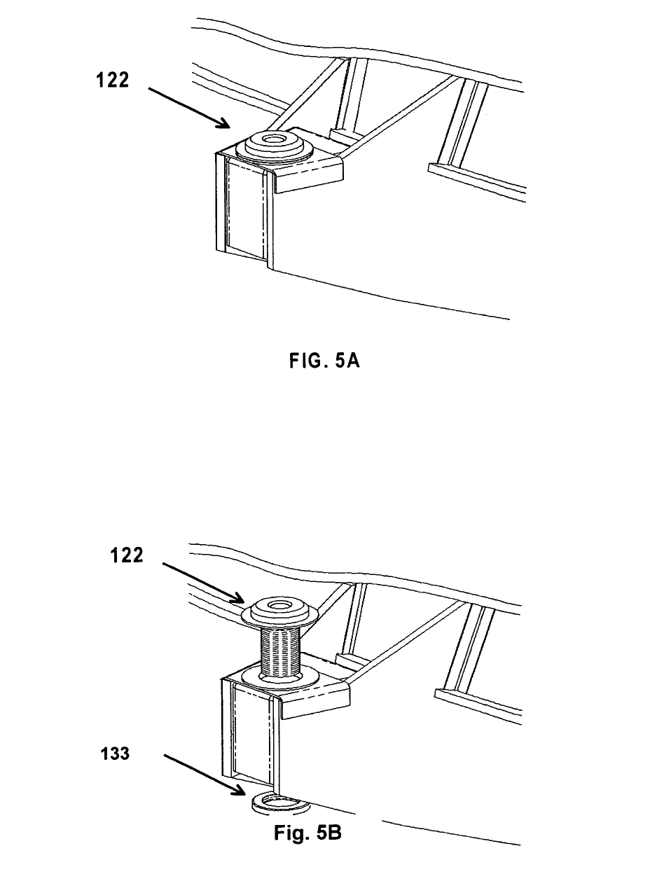

FIGS. 5A and 5B show an improved mechanical joint for the hinge-release mechanism points 22a. As shown, each metal fitting 122 is retained at the respective hinge-release mechanism point 22a by a nut 123. Preferably, the metal fitting 122 and the nut 123 are fabricated from the same material or materials with similar coefficient of thermal expansion. However, even if the nut 123 is made of material having different characteristic such as coefficient of thermal expansion from the material for fabricating the fitting 122, the mechanical attachment between the fitting 122 and the nut 123 is more robust than the bonded only attachment as shown in FIG. 4. Further, the fitting 122 can be made of light-weight and less expensive material such as aluminum. The weight reduction is a desirable feature that increases the value of the reflector structure or the antenna.

The above description is given by way of example, and not limitation. Given the above disclosure, one skilled in the art could devise variations that are within the scope and spirit of the invention. Further, the various features of this invention can be used along, or in varying combinations with each other and are not intended to be limited to the specific combination described herein. Thus, the invention is not to be limited by the illustrated embodiments but is to be defined by the following claims when read in the broadest reasonable manner to preserve the validity of the claims.

What is claimed is:

1. A backing structure of an antenna reflector for satellite communication, wherein the antenna reflector includes a deployable panel attached to a spacecraft at a hinge/gimbal interface and a plurality of hinge-release points, the backing structure comprising:
a plurality of first ribs protruding from the deployable panel and extending across a center of mass of the deployable panel between the hinge-release mechanism points; and
a plurality of second ribs protruding from the deployable panel and extending between the hinge/gimbal interface point to the hinge-release mechanism points, wherein the second ribs extend substantially across the center of mass.

2. The backing structure of claim 1, wherein the first and second ribs are fabricated from sandwich panels of graphite skin and honeycomb core.

3. The backing structure of claim 1, wherein the backing structure includes two hinge-release mechanism points distal to the hinge/gimbal interface point and two hinge-release mechanism points proximal to the hinge/gimbal interface point.

4. The backing structure of claim 3, comprising two first ribs extending between the proximal hinge-release mechanism points and the distal hinge-release mechanism points at different sides of the center of mass.

5. The backing structure of claim 3, comprising two second ribs extending between the hinge-gimbal interface point and the distal hinge-release mechanism points.

6. The backing structure of claim 1, further comprising a third rib extending laterally to connect two of the hinge-release mechanism points.

7. The backing structure of claim 6, wherein the third rib intersects the second ribs.

8. The backing structure of claim 1, wherein each of the hinge-release mechanism point comprises a metal fitting and a nut for retaining the fitting.

9. The backing structure of claim 8, wherein each metal fitting includes a plurality of threads.

10. The backing structure of claim 1, wherein the antenna reflector comprises a dual-shell deployable panel.

11. The backing structure of claim 10, further comprising a circumferential ring interconnecting the dual shells along peripheries thereof.

12. The backing structure of claim 1, wherein the antennal reflector comprises a single-shell deployable panel.

13. An antenna reflector deployably attached to a spacecraft, comprising:
a reflector panel;
a hinge-gimbal interface deployably connecting the reflector panel to the spacecraft;
a plurality of hinge-release mechanisms releasably connecting the reflector panel to the space craft; and
a star-like rib extending between the hinge-gimbal interface and the hinge-release mechanisms to provide a plurality of direct load transfer paths to a center of mass of the reflector panel.

14. The antenna reflector of claim 13, wherein each hinge-release mechanism comprises one threaded metallic fitting and one nut to retain the threaded metallic fitting.

15. The antenna reflector of claim 13, wherein the star-like rib is fabricated from sandwich panels of graphite skin and honeycomb core.

16. The antenna reflector of claim 13, wherein the star-like rib includes two longitudinal ribs extending across the center of mass and connecting the hinge-gimbal interface to two hinge-release mechanisms.

17. The antenna reflector of claim 13, wherein the star-like rib includes two diagonal ribs each extending across the center of mass and connecting two hinge-release mechanisms at two diagonal positions of the reflector panel.

18. The antenna reflector of claim 13, wherein the star-like rib includes one lateral rib connecting two hinge-release mechanisms proximal to the hinge/gimbal interface.

19. The antenna reflector of claim 13, wherein the reflector panel includes a front panel and a rear panel.

20. A method of increasing stiffness of an antenna reflector, wherein the antenna reflector includes a reflector panel deployably connected to a hinge/gimbal interface and releasably connected to a plurality of hinge-release mechanisms of a spacecraft, the method comprising forming a plurality of protruding ribs on the reflector panel to extend across a center of mass of the reflector panel between the hinge-mechanisms.

21. The method of claim 20, further comprising forming two longitudinal ribs extending across the center of mass between the hinge/gimbal interface and two hinge-release mechanisms.

22. The method of claim 20, wherein the protruding ribs include two diagonal ribs extending between the hinge-release mechanisms at the diagonal positions of the reflector panel,

23. The method of claim 20, further comprising forming a lateral protruding rib connecting two hinge-release mechanisms proximal to the hinge/gimbal interface.
